(19) United States
(12) Patent Application Publication
(10) Pub. No.: US 2014/0351273 A1
(43) Pub. Date: Nov. 27, 2014

(54) SYSTEM AND METHOD FOR SEARCHING INFORMATION

(71) Applicant: SAMSUNG SDS CO., LTD., Seoul (KR)

(72) Inventors: Iljee YOON, Seoul (KR); Bori OH, Seoul (KR); Jaeseok CHOI, Seoul (KR)

(73) Assignee: SAMSUNG SDS CO., LTD., Seoul (KR)

(21) Appl. No.: 14/141,788

(22) Filed: Dec. 27, 2013

(30) Foreign Application Priority Data
May 24, 2013 (KR) 10-2013-0058950

(51) Int. Cl. G06F 17/30

(52) U.S. Cl. CPC G06F 17/30699; G06F 17/30657
USPC 707/754; 707/758

(57) ABSTRACT

Provided are a system and method of searching information. The system comprises: a database comprising a data storage area in which data is divided into a plurality of data blocks and stored, and metadata storage areas; a searcher configured to receive, from a user, a keyword search request comprising a targeted keyword and a targeted search range, and to search the data stored in the database using the targeted keyword in a keyword search; and a keyword manager configured to receive, from the searcher, keyword absence information generated from a result of the keyword search, and to store the keyword absence information in the database.

### CROSS-REFERENCE TO RELATED APPLICATION

This application claims priority to and the benefit of Republic of Korea Patent Application No. 10-2013-0058950 filed on May 24, 2013, the disclosure of which is incorporated herein by reference in its entirety.

### BACKGROUND

1. Field

The present disclosure relates to technology for efficiently searching a large amount of data, and more particularly, to a system and method for searching information.

2. Discussion of Related Art

The proliferation of Internet services, such as an electronic commerce, social network service (SNS), and voice over Internet protocol (VoIP), has lead to the development of various means for effectively operating systems for these services. In general, a service system stores and manages log data, such as access records and error records of users, event data of events having occurred in the system, or so on. Such data can be helpfully used in grasping the state of a service system, a service component in the system, etc., and coping with a problem having occurred, or estimating occurrence of a problem in advance.

As a service system is complicated and increases in size and the number of users of the service system increases, the amount of data recorded in the service system also increases. Thus, to effectively use the recorded data, it is required to rapidly and efficiently search the large amount of data for a desired keyword. To this end, an existing data management system uses a method of generating an index of a specific row or a data block of a database that is frequently searched. However, it is very difficult to estimate in advance which piece of data will be frequently searched for by a user, and additional hardware resources are consumed for indexing. Thus, such a method is particularly inefficient in the case of a large amount of data.

In addition, the use of unstructured databases, such as NoSQL, for managing a large amount of data is increasing recently. Such an unstructured database does not support automatic indexing of specific data, and thus it is required to implement an indexing algorithm for indexing.

### SUMMARY

The present disclosure is directed to providing a means for effectively searching a large amount of data, such as log data.

According to an exemplary embodiment of the present disclosure, there is provided a system for searching information, comprising: a database comprising a data storage area in which data is divided into a plurality of data blocks and stored, and metadata storage areas; a searcher configured to receive, from a user, a keyword search request comprising a targeted keyword and a targeted search range, and to search the data stored in the database using the targeted keyword in a keyword search; and a keyword manager configured to receive, from the searcher, keyword absence information generated from a result of the keyword search, and to store the keyword absence information in the database.

The searcher may determine, based on the keyword absence information stored in the database, whether or not a keyword absent range is in the targeted search range, and searches the database within the targeted search range not including the keyword absent range, using the targeted keyword when the keyword absent range is determined to be in the targeted search range.

The keyword manager may be further configured to receive, from the searcher, the targeted search range for the targeted keyword search and the keyword absence information indicating that the targeted keyword is absent in the search range, and to store, in at least one of the metadata storage areas, the keyword absence information, the at least one of metadata storage areas corresponding to at least one of the plurality of data blocks, and the targeted keyword not being present in the at least one of the plurality of data blocks.

The keyword manager may comprise: a first keyword history table configured to store keywords received from the searcher for a determined period of time; a master filter configured to store hash values of the keywords stored in the first keyword history table; and a second keyword history table configured to store keywords conflicting with keywords previously stored in the master filter, among keywords received from the searcher.

The master filter may be a counting bloom filter.

The keyword manager may calculate a number of hash values from the targeted keyword received from the searcher, and store the targeted keyword in the second keyword history table when all values of cells of the master filter are greater than 0, the cells corresponding to the calculated number of hash values.

When at least one of the values of the cells corresponding to the calculated number of hash values, is 0, the keyword manager may increase respective values of the cells corresponding to the calculated number of hash values by one, and store the targeted keyword in the first keyword history table.

The keyword manager may store, in the metadata storage areas, keyword absence information of the targeted keyword stored in the first keyword history table.

When a specific keyword stored in the first keyword history table is not used for a predetermined period of time, the keyword manager may reduce values of cells of the master filter by one, the cells corresponding to hash values of the specific keyword, and remove the specific keyword from the first keyword history table.

When the specific keyword stored in the first keyword history table is removed, the keyword manager may remove, from among keywords stored in the second keyword history table, a keyword which does not conflict any more with the keywords previously stored in the master filter, and register the keyword removed from the second keyword history table, with the first keyword history table and the master filter.

The searcher may determine whether or not the keyword absence information has been stored using the master filter, and acquire information regarding a range in which the targeted keyword is absent by searching the metadata storage areas of the database when it is determined that the keyword absence information has been marked in the database.

According to another exemplary embodiment of the present disclosure, there is provided a method of searching information, comprising: receiving, at a searcher, a keyword search request comprising a targeted keyword and a targeted search range, from a user; searching, at the searcher, data stored in a database using the targeted keyword, in a keyword search; and storing, at a keyword manager, keyword absence information generated from a result of the keyword search in the database.

The method may further comprise, before the searching the data, determining, at the searcher, whether or not a keyword absent range is in the targeted search range based on the keyword absence information stored in the database, wherein the searching the data comprises searching the database within the targeted search range not including the keyword absent range, using the targeted keyword when the keyword absent range is determined to be in the targeted search range.

The storing of the keyword absence information may comprise: receiving, from the searcher, the targeted search range and a search result; determining whether or not the targeted keyword conflicts with keywords previously stored in a master filter; and in accordance with a result of the determining, storing the targeted keyword in a first keyword history table or a second keyword history table.

The master filter may be a counting bloom filter.

The determining of whether or not the targeted keyword conflicts with the keywords previously stored in the master filter may comprise calculating a number of hash values from the targeted keyword received from the searcher, and determining whether or not the targeted keyword conflicts with the keywords stored in the master filter according to whether or not all values of cells of the master filter are greater than 0, the cells corresponding to the calculated number of hash values.

The storing of the targeted keyword may comprise, when at least one of the values of the cells corresponding to the calculated number of hash values is 0, increasing respective values of the cells corresponding to the calculated number of hash values by one, and storing the targeted keyword in the first keyword history table.

The storing of the targeted keyword may comprise, when all the values of the cells corresponding to the calculated number of hash values are greater than 0, storing the targeted keyword in the second keyword history table.

The method may further comprise, after the storing of the keyword absence information, when a specific keyword stored in the first keyword history table is not used for a predetermined period of time, reducing values of cells of the master filter by one, the cells corresponding to hash values of the specific keyword, and removing the specific keyword from the first keyword history table.

The removing of the specific keyword from the first keyword history table may comprise removing, from among keywords stored in the second keyword history table, a keyword which does not conflict any more with the keywords previously stored in the master filter, and registering the keyword removed from the second keyword history table, with the first keyword history table and the master filter.

### BRIEF DESCRIPTION OF THE DRAWINGS

The above and other objects, features, and advantages of the exemplary embodiments of the present disclosure will become more apparent to those familiar with this field from the following detailed description when taken in conjunction with the accompanying drawings, in which:

FIG. 1 is a block diagram of a system for searching information according to an exemplary embodiment of the present disclosure;

FIG. 2 is a block diagram showing a detailed constitution of a database according to an exemplary embodiment of the present disclosure;

FIG. 3 is a block diagram showing a detailed constitution of a searcher according to an exemplary embodiment of the present disclosure;

FIG. 4 is a block diagram showing a detailed constitution of a keyword manager according to an exemplary embodiment of the present disclosure;

FIG. 5 is a flowchart illustrating a process of the keyword manager adding a new keyword according to an exemplary embodiment of the present disclosure;

FIG. 6 is a diagram showing an example of a master filter according to an exemplary embodiment of the present disclosure;

FIG. 7 is a diagram showing an example of a state in which a new keyword is added to the master filter shown in FIG. 6;

FIG. 8 is a flowchart illustrating a process of the keyword manager removing a keyword according to an exemplary embodiment of the present disclosure;

FIG. 9 is a diagram showing an example of a state in which a specific keyword has been removed from the master filter shown in FIG. 7;

FIG. 10 is a flowchart illustrating a keyword search and metadata update process according to an exemplary embodiment of the present disclosure; and

FIG. 11 is a flowchart illustrating a keyword search process using keyword absence information according to an exemplary embodiment of the present disclosure.

### DETAILED DESCRIPTION OF EXEMPLARY EMBODIMENTS

Exemplary embodiments of the present disclosure will be described below with reference to drawings. However, the embodiments are merely examples and are not to be construed as limiting the present disclosure.

Various details already understood by those familiar with this field will be omitted to avoid obscuring the gist of the present disclosure. Terminology described below is defined considering functions in the present disclosure and may vary according to a user's or operator's intention or usual practice. Thus, the meanings of the terminology should be interpreted based on the overall context of the present specification.

The spirit of the present disclosure is determined by the claims, and the following exemplary embodiments are provided only to efficiently describe the spirit of the present disclosure to those of ordinary skill in the art.

FIG. 1 is a block diagram of a system for searching information according to an exemplary embodiment of the present invention. As shown in the drawing, a system 100 for searching information according to an exemplary embodiment of the present invention includes a database 102, a searcher 104, and a keyword manager 106.

The database 102 stores data that is a search target. In an exemplary embodiment of the present invention, the data stored in the database 102 may be log or event information, for example, access records and the details of an error, generated when a service system providing a service, such as voice over Internet protocol (VoIP), on the Internet operates. However, exemplary embodiments of the present invention are not limited to a specific kind of data, and the present invention can be applied to any kind of data. The database 102 may be configured as an unstructured database such as NoSQL, or as a relational database management system (RDBMS), etc. excluding an unstructured database.

The searcher 104 receives a keyword search request from a user, and searches data stored in the database 102 using a targeted keyword included in the keyword search request. The keyword may be, for example, a log stored in the database 102, important message text included in an event message, a user account (identification (ID)) registered as a monitoring target, or so on.

In addition to the targeted keyword, the keyword search request may further include a targeted search range for searching for the targeted keyword. For example, the user may request a search for whether or not a specific error message (e.g., a message such as “DBError”) or an access record of a specific person (e.g., an access log of a user whose ID is “ABC”) is included in data stored in the database 102 for the last seven days.

The keyword manager 106 receives keyword absence information from the searcher 104 according to a result of the keyword search performed by the searcher 104, and records the keyword absence information in the database 102. For example, when the search result in accordance with the user's search request is that a “DBError” message has occurred on the first day of the last seven days, that is, a search period of time, the searcher 104 transmits a message providing a notification that no “DBError” message has occurred for the other six days (keyword absence information) to the keyword manager 106, and the keyword manager 106 may record the received keyword absence information in the database 102.

In an exemplary embodiment of the present invention, the message related to the keyword absence information may be configured in various forms. For example, the searcher 104 may transmit the search result and the search range for the keyword search to the keyword manager 106 as they are, or calculate a keyword absence range from the search result and the search range and transmit the calculated keyword absence range to the keyword manager 106.

When there is a search request for the same keyword after the absence information dependent on the search result of the searched keyword is recorded in the database 102, the searcher 104 performs the requested keyword search in a targeted search range except a range recorded as the data absence range with reference to the keyword absence information recorded in the database 102. For example, when a search request for a keyword “DBError” is received again, the searcher 104 determines whether or not a keyword absence range is in a received targeted search range using keyword absence information recorded in the database 102, and searches for the targeted keyword in the targeted search range except the keyword absent range when there is the keyword absence range. Accordingly, in exemplary embodiments of the present disclosure, the more a search for a frequently searched keyword is repeated, the higher a data search rate is.

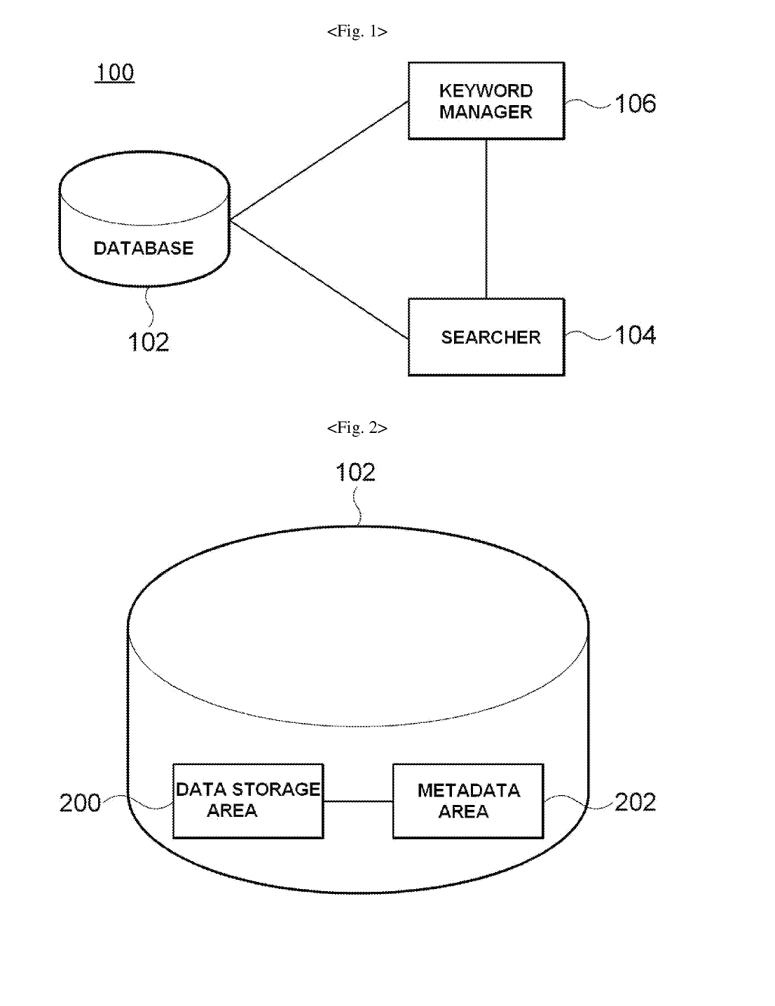

FIG. 2 is a block diagram showing a detailed constitution of a database according to an exemplary embodiment of the present disclosure. As shown in the drawing, the database 102 according to an exemplary embodiment of the present disclosure includes a data storage area 200 and a metadata area 202.

The data storage area 200 stores data that is a search target. The data storage area 200 may be configured to divide the data into a plurality of data blocks and store the divided data. For example, the data storage area 200 may be configured to divide data in time units, such as a single day or week, and store the divided pieces of data in different data blocks, respectively.

The metadata area 202 stores keyword-specific absence information on the data stored in the data storage area 200. As described above, the data storage area 200 may divide data into a plurality of blocks and store the divided data, and in this case, the metadata area 202 may store keyword absence information according to the respective data blocks. In other words, with reference to the metadata area 202, it is possible to easily find a data block in which data being searched for is not stored. In an exemplary embodiment, the metadata area 202 may store keyword absence information according to the respective data blocks using a bloom filter, but the present disclosure is not limited to a specific data structure for storing keyword absence information.

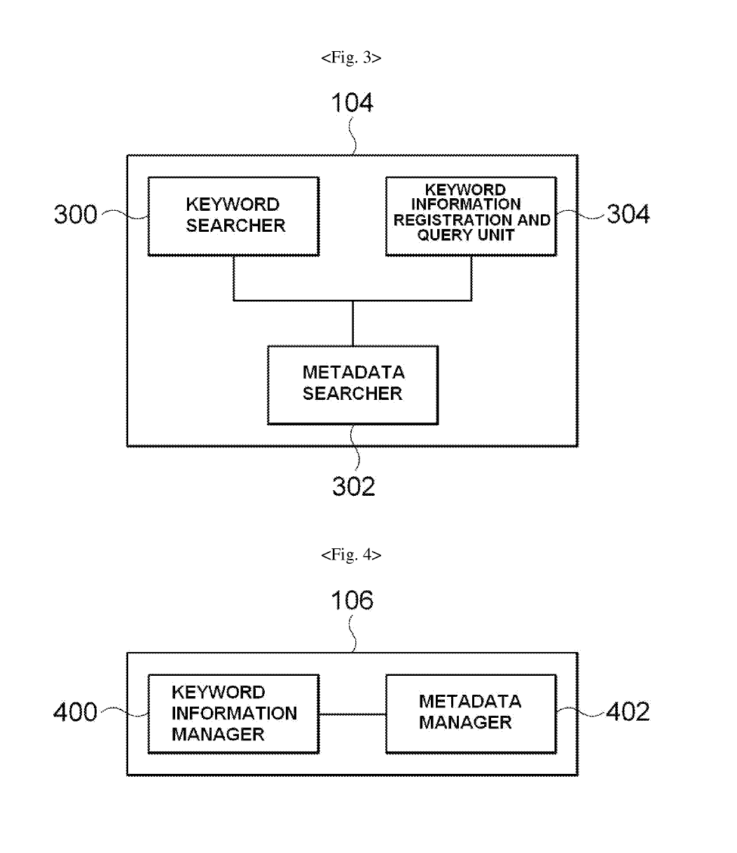

FIG. 3 is a block diagram showing a detailed constitution of a searcher according to an exemplary embodiment of the present disclosure. As shown in the drawing, the searcher 104 according to an exemplary embodiment of the present disclosure includes a keyword searcher 300, a metadata searcher 302, and a keyword information registration and query unit 304.

The keyword searcher 300 receives a keyword search request from a user, performs a search in the data storage area 200 of the database 102 using at least one keyword according to the keyword search request, and returns a search result to the user.

The metadata searcher 302 searches the metadata area 202 of the database 102, thereby determining whether or not a range in which the requested keyword is not present (a keyword absent range) is in a targeted search range for the keyword. When a result of the search of the metadata area 202 is that the keyword absent range is in the targeted search range, the keyword searcher 300 performs a search for the keyword only in the targeted search range except the keyword absent range.

The keyword information registration and query unit 304 registers keyword information including the result of the search performed by the keyword searcher 300 with the keyword manager 106, which will be described below. Also, when the keyword search request is received, the keyword information registration and query unit 304 queries information on the received targeted keyword to the keyword manager 106, and receives a result of the query. A detailed configuration related to the registration and query of keyword information will be described later.

FIG. 4 is a block diagram showing a detailed constitution of a keyword manager according to an exemplary embodiment of the present disclosure. As shown in the drawing, the keyword manager 106 according to an exemplary embodiment of the present disclosure includes a keyword information manager 400 and a metadata manager 402.

The keyword information manager 400 stores keyword information received from the keyword information registration and query unit 304. When a request for keyword information is received from the keyword information registration and query unit 304, the keyword information manager 400 provides keyword information corresponding to the request. Also, the metadata manager 402 marks absence information on each keyword received by the keyword information manager 400 in the metadata area 202 of the database 102.

In an exemplary embodiment of the present disclosure, keyword information denotes history information on a keyword that is currently used in the database 102. In other words, in the case of log data, the latest data is searched more times and more frequently than previous data, and thus information on keywords that are frequently searched for at the current point of time is stored to enable a more efficient search.

In an exemplary embodiment, to manage keyword information, the keyword information manager 400 may use three data structures including a keyword history table, a master filter, and a conflicting keyword history table.

First, the keyword history table is a data structure for storing keywords received from the searcher 104 for a predetermined period of time. For example, the keyword history table may be configured to store keywords received from the searcher 104 for the last seven days. According to an exemplary embodiment, the keyword history table may be configured to store past search keywords as well as recent search keywords. For example, the keyword history table may include a plurality of blocks, and may be configured to store search keywords of the latest period of time (e.g., last seven days) in a first block, search keywords of the previous period of time (eighth to 14^{th} days) in a second block, and search keywords of the previous period of time (15^{th} to 21^{st} days) in a third block. In this case, the keywords stored in the first block can be regarded as keywords that are frequently being searched for at the current time.

The master filter stores hash values of the keywords stored in the keyword history table. The master filter may be implemented using, for example, a counting bloom filter. As described above, when the keyword history table stores the keywords that have been searched for in the past as well, the master filter may only store the keywords that have been searched for in the latest period of time among all the keywords stored in the keyword history table. When a keyword stored in the master filter is not used for a predetermined period of time, the keyword may be removed from the master filter.

The conflicting keyword history table is a data structure in which, among the keywords received from the searcher 104, a keyword conflicting with a keyword previously stored in the master filter is stored. Specifically, when a keyword is received from the searcher 104, the keyword information manager 400 determines whether or not the keyword can be stored in the master filter. The keyword information manager 400 stores the keyword in the keyword history table when the keyword can be stored in the master filter, and stores the keyword in the conflicting keyword history table when the keyword cannot be stored in the master filter.

With reference to FIGS. 5 to 9, keyword addition and removal processes using the keyword history table, the master filter, and the conflicting keyword history table will be described below.

FIG. 5 is a flowchart illustrating a process of a keyword manager adding a new keyword according to an exemplary embodiment of the present disclosure. First, when a keyword that has not been used before is newly received from the searcher 104 (502), the keyword information manager 400 of the keyword manager 106 calculates a plurality of hash values by applying a predetermined number of different hash functions to the received keyword (504), and determines whether or not the received keyword can be added to the master filter according to cell values of the master filter respectively corresponding to the calculated hash values (508).

For example, it is assumed that a new keyword “abc” which has not been previously stored in the keyword information manager 400 is newly received from the searcher 104. The keyword information manager 400 calculates a plurality of hash values by applying a plurality of different hash functions to the received keyword “abc.” For example, it is assumed that results obtained by applying three different hash functions to the keyword are 3, 6, and 100. Then, the keyword information manager 400 reads values previously stored in third, sixth, and 100^{th} cells of the master filter, and then determines whether or not the received keyword can be added to the master filter according to whether or not a value of each cell is greater than 0.

Specifically, when at least one of the cell values of the master filter corresponding to the calculated hash values is 0, the keyword information manager 400 increases the respective cell values of the master filter corresponding to the hash values by one, and thereby stores the corresponding keyword in the master filter (510).

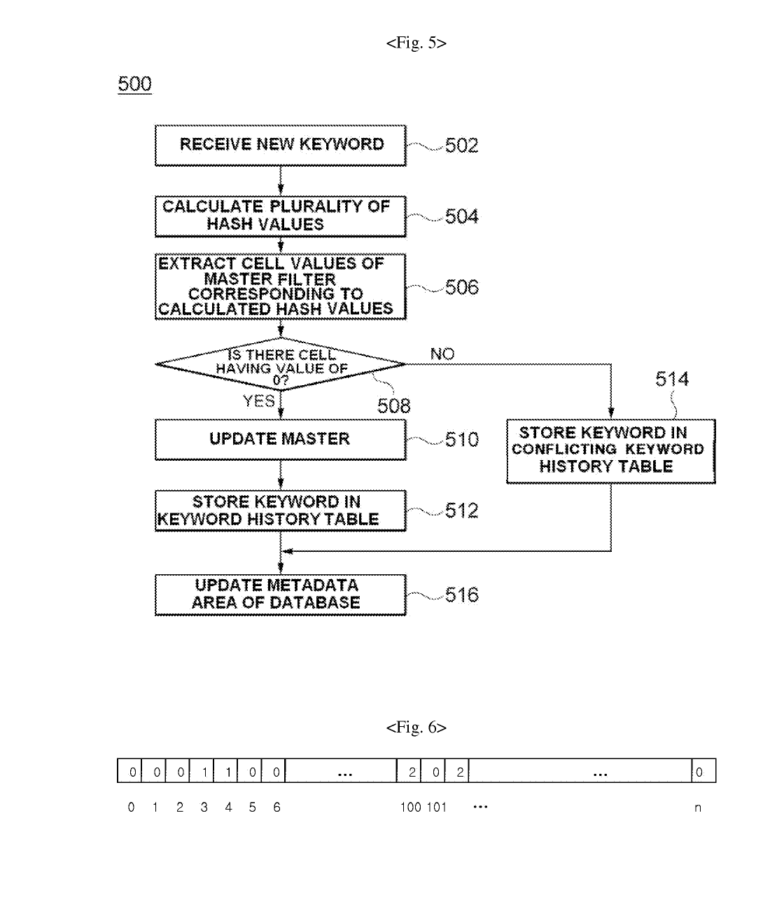

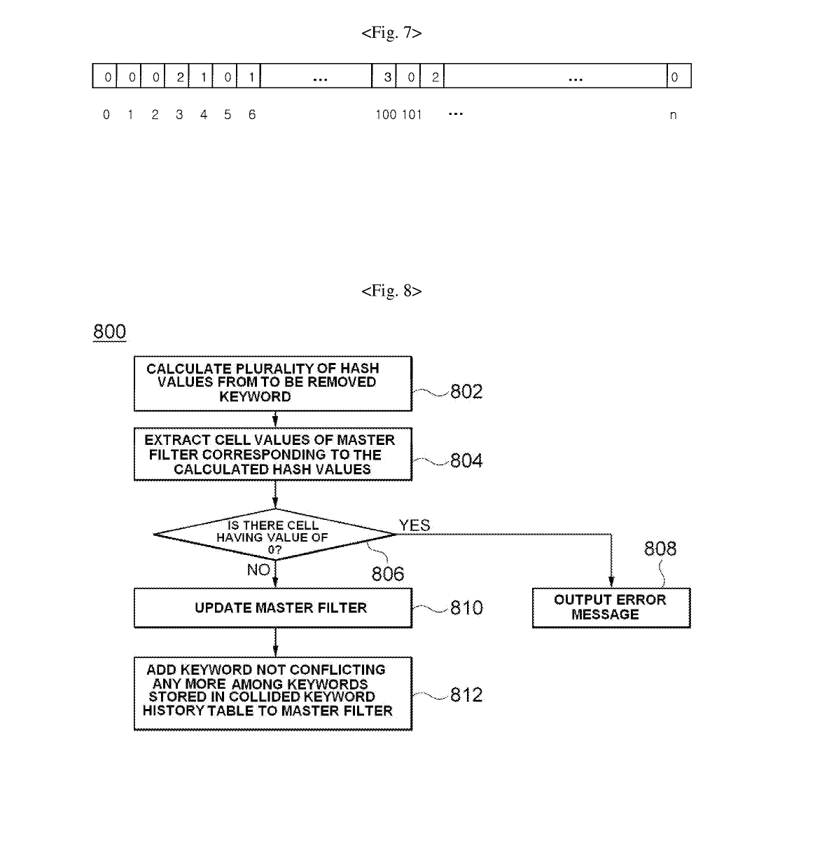

FIG. 6 and FIG. 7 are diagrams showing an example of a master filter update process by a keyword information manager. In the drawings, respective quadrangles denote respective cells of the master filter, numerals in the quadrangles denote values of the respective cells, and numerals under the quadrangles denote serial numbers of the respective cells. For example, when the third, sixth, and 100^{th} cells of the master filter have values of 1, 0, and 2 respectively, the keyword information manager 400 increases the values of the respective cells corresponding to the hash values by one as shown in FIG. 7. In other words, in this case, the values of the third, sixth, and 100^{th} cells become 2, 1, and 3, respectively.

In addition, when a new keyword is added to the master filter as described above, the keyword information manager 400 stores the newly added keyword in the keyword history table (512).

On the other hand, when all the values of the cells corresponding to the calculated hash values among the cells of the master filter are greater than 0, the keyword information manager 400 cannot add the keyword to the master filter. The reason is that this is a case in which “True” is returned in response to a query about the keyword though the keyword is not added to a bloom filter or a counting bloom filter, in other words, a positive false of the keyword occurs. Thus, in this case, the keyword information manager 400 stores the keyword in the conflicting keyword history table (514).

When the new keyword is stored in one of the keyword history table and the conflicting keyword history table through such a process, the metadata manager 402 lastly updates the metadata area 202 of the database 102 by marking absence information on the newly stored keyword in the metadata area 202 (516).

In an exemplary embodiment of the present disclosure, the reason that the conflicting keyword history table is managed in addition to the master filter is as follows. As described above, the master filter uses a counting bloom filter as a data structure, and thus there is a probability of a positive false that “True” is returned for a keyword query even if a keyword is not actually stored. In the present disclosure, a problem may occur because the counting bloom filter is used not for indicating the presence of a specific keyword but for indicating the absence of the keyword. In other words, due to a positive false that is a characteristic of the counting bloom filter, a range in which a keyword is actually present may be incorrectly determined as a keyword absent range. In this case, a keyword search is not performed in the range incorrectly determined as a keyword absent range, and there is a probability that a search result is distorted. Therefore, the present disclosure is configured to prevent a positive false from occurring by additionally storing a keyword that conflicts with a previously stored keyword and thus cannot be added in the conflicting keyword history table.

FIG. 8 is a flowchart illustrating a process of the keyword manager removing a keyword according to an exemplary embodiment of the present disclosure.

The keyword information manager 400 of the keyword manager 106 designates, as a keyword to be removed, a specific keyword that is stored in the keyword history table but has not been used for a previously set period of time, and calculates a plurality of hash values from the keyword to be removed (802). After that, the keyword manager 106 extracts respective cell values of the master filter corresponding to the calculated hash values (804), and determines whether or not the keyword can be removed according to the respective cell values (806).

When there is at least one cell having a value of 0 among the extracted cell values of the master filter, the keyword cannot be removed from the master filter, and thus the keyword information manager 400 outputs an error message indicating that the keyword cannot be removed (808). On the other hand, when all the extracted cell values of the master filter are greater than 0, the keyword information manager 400 reduces the cell values of the master filter corresponding to the calculated hash values by one, and thereby removes the removal target keyword from the keyword history table (810). FIG. 9 shows an example of a state in which the keyword “abc” has been removed from the master filter shown in FIG. 7 through such a process. In other words, the keyword information manager 400 reduces the third, sixth, and 100^{th} cell values of the master filter corresponding to the keyword “abc” from 2, 1, and 3 to 1, 0, and 2.

When a keyword is removed from the master filter, the keyword information manager 400 may remove a keyword that does not conflict any more due to the keyword removal among keywords stored in the conflicting keyword history table from the conflicting keyword history table, and newly add the keyword to the master filter (812).

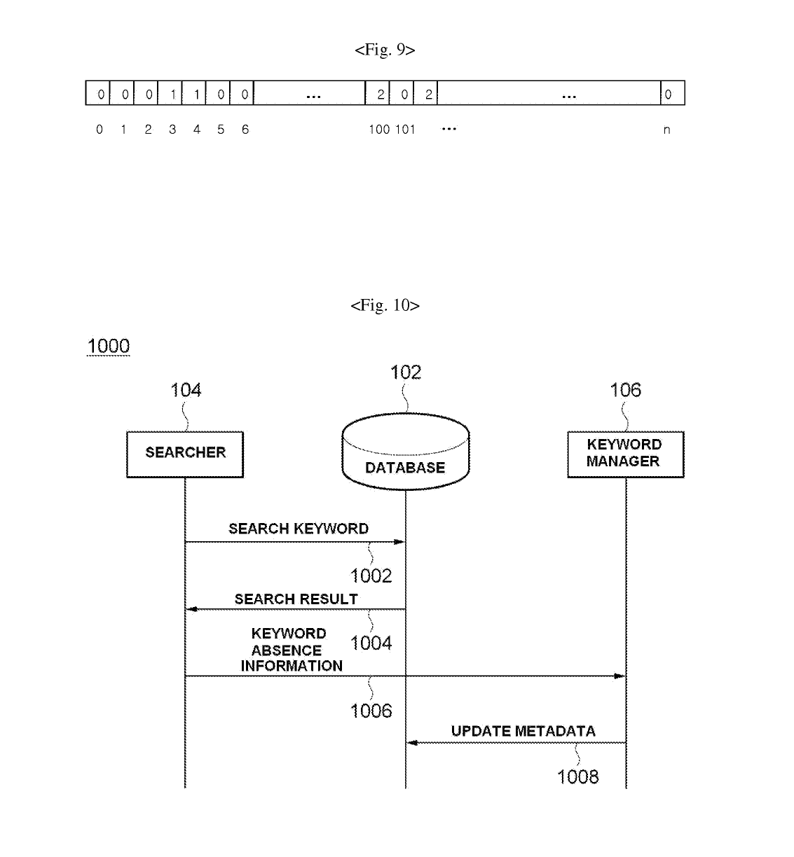

FIG. 10 is a flowchart illustrating a keyword search and metadata update process according to an exemplary embodiment of the present disclosure.

First, the searcher 104 transmits a keyword search query to the database 102 using targeted keyword and targeted search range information received from a user (1000), and the database 102 performs a search according to the received keyword search query and then returns a search result (1004).

Subsequently, the searcher 104 transmits keyword absence information dependent on the received search result to the keyword manager 106 (1006), and the keyword manager 106 marks the keyword absence information in the metadata area 202 of the database 102 according to the received keyword absence information (1008).

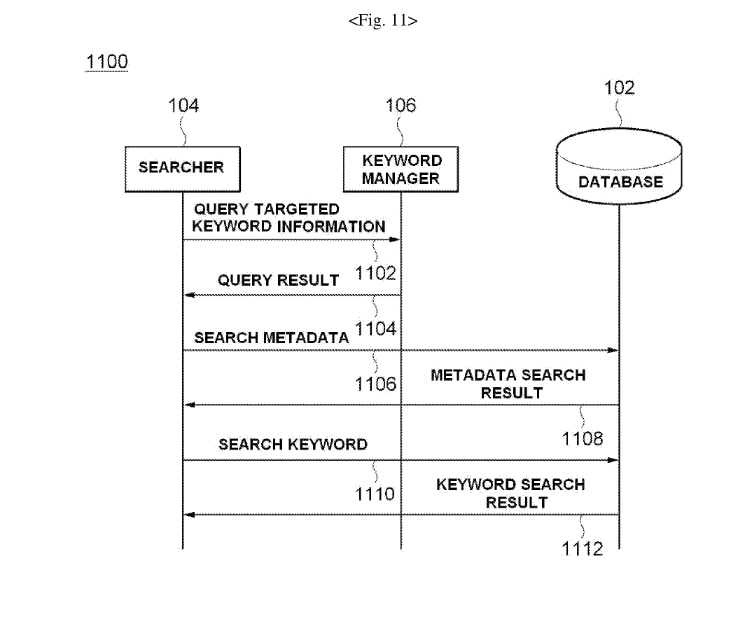

FIG. 11 is a flowchart illustrating a keyword search process using keyword absence information according to an exemplary embodiment of the present disclosure.

First, the searcher 104 receives a keyword search request including a targeted keyword and a targeted search range from a user, and queries information on the targeted keyword included in the received search request to the keyword manager 106 (1102).

The keyword manager 106 receiving the query searches whether or not the received targeted keyword is stored in one of the master filter or the conflicting keyword history table, and transmits the search result to the searcher 104 (1104).

When the search result is that the targeted keyword is stored in the master filter, the searcher 104 searches the metadata area 202 of the database 102 for a keyword absent range for the keyword to acquire absence range information on the targeted keyword (1106 and 1108), and performs a search for the targeted keyword in the targeted search range except the range (1110 and 1112). In other words, in this case, the absence information on the keyword is marked in the database 102. Thus, the keyword absent range is removed using metadata, and the search is performed only in the targeted search range except the keyword absent range.

On the other hand, a case in which the targeted keyword has been stored in the conflicting keyword history table or has no history of having been stored in the keyword manager 106 corresponds to a case in which it has been impossible to mark the keyword due to a collision or the keyword has no history of having been searched for before. Thus, the searcher 104 performs a search for the targeted keyword in the entire targeted search range.

Meanwhile, exemplary embodiments of the present disclosure may include a computer-readable recording medium including a program for performing the methods described herein on a computer. The computer-readable recording medium may separately include program commands, local data files, local data structures, etc. or include a combination of them. The medium may be specially designed and configured for the present disclosure, or known and available to those of ordinary skill in the field of computer software. Examples of the computer-readable recording medium include magnetic media, such as a hard disk, a floppy disk, and a magnetic tape, optical recording media, such as a CD-ROM and a DVD, magneto-optical media, such as a floptical disk, and hardware devices, such as a ROM, a RAM, and a flash memory, specially configured to store and perform program commands. Examples of the program commands may include high-level language codes executable by a computer using an interpreter, etc. as well as machine language codes made by compilers.

In exemplary embodiments of the present disclosure, by tagging an absence range of a specific keyword in a database using results of a previously performed search, it is possible to minimize a range in which a keyword search will be performed and improve search efficiency.

In addition, by separately managing keywords conflicting with previously tagged keywords during the data absence tagging, it is possible to prevent a positive false from occurring in a search of an absence range.

It will be apparent to those skilled in the art that various modifications can be made to the above-described exemplary embodiments of the present disclosure without departing from the spirit or scope of the disclosure. Thus, it is intended that the present disclosure covers all such modifications provided they come within the scope of the appended claims and their equivalents.

What is claimed is:

1. A system for searching information, comprising:
a database comprising a data storage area in which data is divided into a plurality of data blocks and stored, and metadata storage areas;
a searcher configured to receive, from a user, a keyword search request comprising a targeted keyword and a targeted search range, and to search the data stored in the database using the targeted keyword in a keyword search; and
a keyword manager configured to receive, from the searcher, keyword absence information generated from a result of the keyword search, and to store the keyword absence information in the database.

2. The system of claim 1, wherein the searcher determines, based on the keyword absence information stored in the database, whether or not a keyword absent range is in the targeted search range, and searches the database within the targeted search range not including the keyword absent range, using the targeted keyword when the keyword absent range is determined to be in the targeted search range.

3. The system of claim 1, wherein the keyword manager is further configured to receive, from the searcher, the targeted search range for the targeted keyword search and the keyword absence information indicating that the targeted keyword is absent in the search range, and to store, in at least one of the metadata storage areas, the keyword absence information, the at least one of metadata storage areas corresponding to at least one of the plurality of data blocks, and the targeted keyword not being present in the at least one of the plurality of data blocks.

4. The system of claim 3, wherein the keyword manager comprises:
a first keyword history table configured to store keywords received from the searcher for a determined period of time;
a master filter configured to store hash values of the keywords stored in the first keyword history table; and
a second keyword history table configured to store keywords conflicting with keywords previously stored in the master filter, among keywords received from the searcher.

5. The system of claim 4, wherein the master filter is a counting bloom filter.

6. The system of claim 5, wherein the keyword manager calculates a number of hash values from the targeted keyword received from the searcher, and stores the targeted keyword in the second keyword history table when all values of cells of the master filter are greater than 0, the cells corresponding to the calculated number of hash values.

7. The system of claim 6, wherein, when at least one of the values of the cells corresponding to the calculated number of hash values, is 0, the keyword manager increases respective values of the cells corresponding to the calculated number of hash values by one, and stores the targeted keyword in the first keyword history table.

8. The system of claim 7, wherein the keyword manager stores, in the metadata storage areas, keyword absence information of the targeted keyword stored in the first keyword history table.

9. The system of claim 5, wherein, when a specific keyword stored in the first keyword history table is not used for a predetermined period of time, the keyword manager reduces values of cells of the master filter by one, the cells corresponding to hash values of the specific keyword, and removes the specific keyword from the first keyword history table.

10. The system of claim 9, wherein, when the specific keyword stored in the first keyword history table is removed, the keyword manager removes, from among keywords stored in the second keyword history table, a keyword which does not conflict any more with the keywords previously stored in the master filter, and registers the keyword removed from the second keyword history table, with the first keyword history table and the master filter.

11. The system of claim 4, wherein the searcher determines whether or not the keyword absence information has been stored using the master filter, and acquires information regarding a range in which the targeted keyword is absent by searching the metadata storage areas of the database when it is determined that the keyword absence information has been marked in the database.

12. A method of searching information, comprising:
receiving, at a searcher, a keyword search request comprising a targeted keyword and a targeted search range, from a user;
searching, at the searcher, data stored in a database using the targeted keyword, in a keyword search; and
storing, at a keyword manager, keyword absence information generated from a result of the keyword search in the database.

13. The method of claim 12, further comprising, before the searching the data, determining, at the searcher, whether or not a keyword absent range is in the targeted search range based on the keyword absence information stored in the database,
wherein the searching the data comprises searching the database within the targeted search range not including the keyword absent range, using the targeted keyword when the keyword absent range is determined to be in the targeted search range.

14. The method of claim 12, wherein the storing of the keyword absence information comprises:
receiving, from the searcher, the targeted search range and a search result;
determining whether or not the targeted keyword conflicts with keywords previously stored in a master filter; and
in accordance with a result of the determining, storing the targeted keyword in a first keyword history table or a second keyword history table.

15. The method of claim 14, wherein the master filter is a counting bloom filter.

16. The method of claim 15, wherein the determining of whether or not the targeted keyword conflicts with the keywords previously stored in the master filter comprises calculating a number of hash values from the targeted keyword received from the searcher, and determining whether or not the targeted keyword conflicts with the keywords stored in the master filter according to whether or not all values of cells of the master filter are greater than 0, the cells corresponding to the calculated number of hash values.

17. The method of claim 16, wherein the storing of the targeted keyword comprises, when at least one of the values of the cells corresponding to the calculated number of hash values is 0, increasing respective values of the cells corresponding to the calculated number of hash values by one, and storing the targeted keyword in the first keyword history table.

18. The method of claim 16, wherein the storing of the targeted keyword comprises, when all the values of the cells corresponding to the calculated number of hash values are greater than 0, storing the targeted keyword in the second keyword history table.

19. The method of claim 17, further comprising, after the storing of the keyword absence information, when a specific keyword stored in the first keyword history table is not used for a predetermined period of time, reducing values of cells of the master filter by one, the cells corresponding to hash values of the specific keyword, and removing the specific keyword from the first keyword history table.

20. The method of claim 19, wherein the removing of the specific keyword from the first keyword history table comprises removing, from among keywords stored in the second keyword history table, a keyword which does not conflict any more with the keywords previously stored in the master filter, and registering the keyword removed from the second keyword history table, with the first keyword history table and the master filter.
